(19) United States
(12) Patent Application Publication
(10) Pub. No.: US 2025/0076024 A1
(43) Pub. Date: Mar. 6, 2025

(54) ROTATION DETECTION DEVICE

(71) Applicant: DENSO CORPORATION, Kariya-city (JP)

(72) Inventors: NAO UEMATSU, Kariya-city (JP); TOSHIHIRO FUJITA, Kariya-city (JP)

(21) Appl. No.: 18/949,529

(22) Filed: Nov. 15, 2024

Related U.S. Application Data
(63) Continuation of application No. PCT/JP2023/017514, filed on May 10, 2023.

(30) Foreign Application Priority Data
May 19, 2022 (JP) 2022-082338

(51) Int. Cl. G01B 7/30; B62D 15/02; G01D 5/14

(52) U.S. Cl. CPC G01B 7/30; B62D 15/0235; G01D 5/14

(57) ABSTRACT

A rotation angle sensor has at least three detection elements for detecting a change in a physical quantity corresponding to a rotation position of a detection target, outputs rotation number information of the detection target corresponding to a detection value of at least one of the detection elements, and outputs rotation angle information of the detection target corresponding to the detection values of each of the detection elements as at least one analog signal and at least one digital signal. A control unit has an absolute angle calculation part and an abnormality determination part. The absolute angle calculation part outputs to a control calculation portion an absolute angle calculated using either the analog rotation angle, which is a rotation angle based on an analog signal, or the digital rotation angle, which is a rotation angle based on a digital signal, that is determined to be normal.

### CROSS REFERENCE TO RELATED APPLICATIONS

This application is a continuation application of International Patent Application No. PCT/JP2023/017514 filed on May 10, 2023, which designated the U.S. and based on and claims the benefits of priority of Japanese Patent Application No. 2022-082338 filed on May 19, 2022.

### TECHNICAL FIELD

The present disclosure relates to a rotation detection device.

### BACKGROUND ART

There is known a device that generates information about a rotation angle of a motor based on a detection value of a detection element.

### SUMMARY

An object of the present disclosure is to provide a rotation detection device capable of calculating an angle information with relatively little delay.

A rotation detection device of the present disclosure includes a rotation angle sensor and a control unit. The rotation angle sensor has at least three sensor elements that detect a change in a physical quantity according to a rotational position of a detection target. The rotation detection device outputs number of rotations information relating to the number of rotations of the detection target according to a detection value of at least one detection element. The rotation detection device also outputs rotation angle information relating to the rotation angle of the detection target corresponding to the detection values of the respective detection elements as at least one analog signal and at least one digital signal.

The control unit has an absolute angle calculation part that calculates an absolute angle, which is the amount of rotation from a reference position, using the rotation angle information and the number of rotations information, and an abnormality determination part that determines whether the rotation angle information is abnormal. The absolute angle calculation part outputs to a control calculation portion an absolute angle calculated using either the analog rotation angle, which is a rotation angle based on an analog signal, or the digital rotation angle, which is a rotation angle based on a digital signal, that is determined to be normal.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic configuration view of a steering system according to a first embodiment;

FIG. 2 is a block view showing a rotation detection device according to the first embodiment;

FIG. 3 is an explanatory diagram illustrating an absolute angle according to the first embodiment;

FIG. 4 is a time chart illustrating digital and analog signals according to the first embodiment;

FIG. 5 is a flowchart for explaining angle calculation processing according to the first embodiment;

FIG. 6 is a flowchart for explaining angle calculation processing according to a second embodiment;

FIG. 7 is a flowchart illustrating an angle calculation processing according to a third embodiment;

FIG. 8 is a flowchart illustrating an angle calculation processing according to a fourth embodiment; and

FIG. 9 is a flowchart illustrating an angle calculation processing according to a fifth embodiment.

### DETAILED DESCRIPTION

In an assumable example, a device generates information about a rotation angle of a motor based on a detection value of a detection element. A sensor unit is provided with an angle calculation part and a calculation part for the number of rotations, and an output signal is output to a microcomputer via digital communication such as SPI communication.

In the example, information relating to the rotation angle and the number of rotations is transmitted to a microcomputer via digital communication, which causes calculation delays due to digital calculations and outputs. An object of the present disclosure is to provide a rotation detection device capable of calculating an angle information with relatively little delay.

A rotation detection device of the present disclosure includes a rotation angle sensor and a control unit. The rotation angle sensor has at least three sensor elements that detect a change in a physical quantity according to a rotational position of a detection target. The rotation detection device outputs number of rotations information relating to the number of rotations of the detection target according to a detection value of at least one detection element. The rotation detection device also outputs rotation angle information relating to the rotation angle of the detection target corresponding to the detection values of the respective detection elements as at least one analog signal and at least one digital signal.

The control unit has an absolute angle calculation part that calculates an absolute angle, which is the amount of rotation from a reference position, using the rotation angle information and the number of rotations information, and an abnormality determination part that determines whether the rotation angle information is abnormal. The absolute angle calculation part outputs to a control calculation portion an absolute angle calculated using either the analog rotation angle, which is a rotation angle based on an analog signal, or the digital rotation angle, which is a rotation angle based on a digital signal, that is determined to be normal. By outputting at least a portion of the detection values from the rotation angle sensor to the control unit as an analog signal, angle calculation can be performed with relatively little delay.

Hereinafter, a rotation detection device according to the present disclosure will be described based on the drawings. In the following plural embodiments, substantially same structural configurations are designated with the same reference numerals thereby to simplify the description.

### First Embodiment

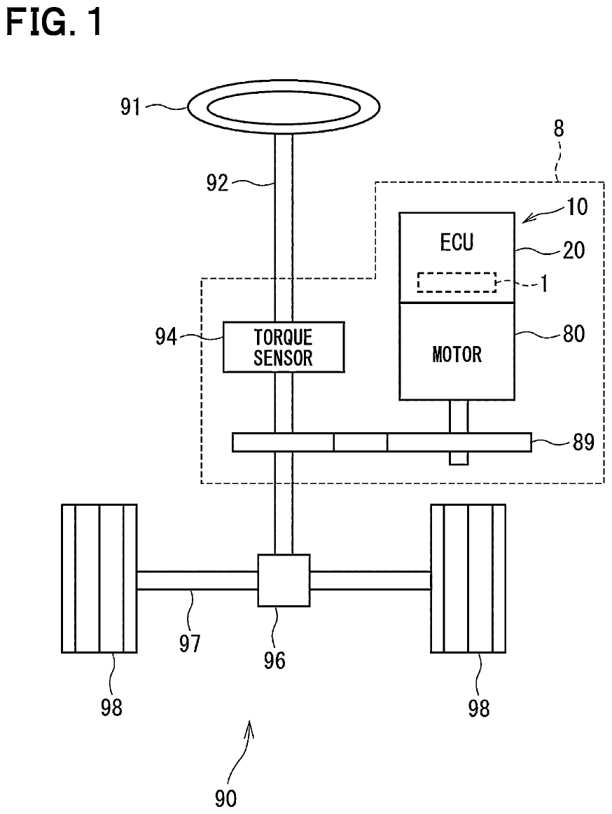

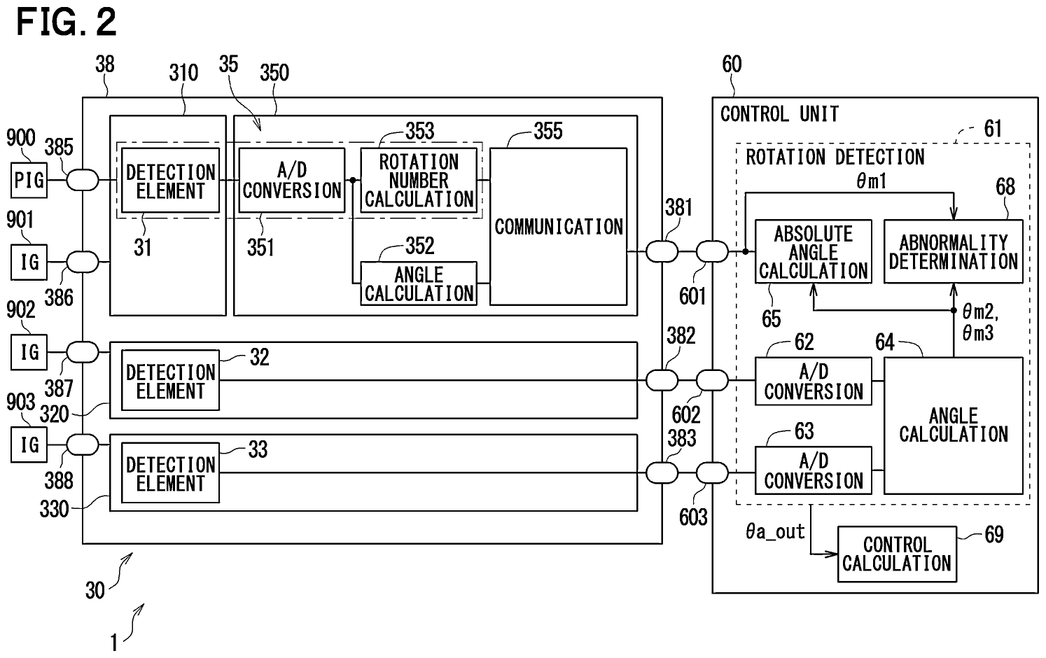

A first embodiment will be described based on FIGS. 1 to 5. As shown in FIGS. 1 and 2, the rotation detection device 1 includes a rotation angle sensor 30 and a control unit 60, and is applied to an electric power steering device 8. FIG. 1 shows a configuration of a steering system 90 including the electric power steering device 8. The steering system 90 includes a steering wheel 91 which is a steering member, a steering shaft 92, a pinion gear 96, a rack shaft 97, road wheels 98 and the electric power steering device 8.

The steering wheel 91 is connected to the steering shaft 92. A torque sensor 94 is provided on the steering shaft 92 to detect a steering torque. A pinion gear 96 is provided at an axial end of the steering shaft 92. The pinion gear 96 meshes with a rack shaft 97. A pair of road wheels 98 is coupled at both ends of the rack shaft 97 via, for example, tie rods.

When a driver of the vehicle steers the steering wheel 91, the steering shaft 92 connected to the steering wheel 91 rotates. A rotational movement of the steering shaft 92 is converted into a linear movement of the rack shaft 97 by the pinion gear 96. The pair of wheels 98 is steered to an angle corresponding to the displacement amount of the rack shaft 97.

The electric power steering device 8 includes a drive device 10 having an ECU 20 and a motor 80, a reduction gear 89 that is a power transmission unit that reduces rotation of the motor 80, and transmits the reduced rotation to the steering shaft 92. That is, the electric power steering device 8 of the present embodiment is a column assist type, in which the steering shaft 92 is an object to be driven. The electric power steering device 800 may be a rack assist type, in which the rotation of the motor 80 is transmitted to the rack shaft 97.

The motor 80 outputs part or all of a torque required for steering, and is driven by a power supplied from a battery (not shown) to rotate the reduction gear 89 forward and backward. The drive device 10 is a so-called “mechanically and electrically integrated type” in which the ECU 20 is provided on one side in an axial direction of the motor 80, but it may be a mechanical and electrically separated type in which the motor and the ECU are separately provided. By adopting a mechanical and electrical integrated type, the ECU 20 and the motor 80 can be efficiently arranged in a vehicle having a limited mounting space. The ECU 20 is positioned coaxially with an axis of the shaft 870 on a side opposite to the output shaft of the motor 80. The ECU 20 is provided with a rotation detection device 1.

As shown in FIG. 2, the rotation angle sensor 30 has detection elements 31 to 33 and a signal processing unit 35. The detection elements 31, 32, and 33 are provided on sensor chips 310, 320, and 330, respectively, and the signal processing unit 35 is provided on a signal processing chip 350. The sensor chips 310, 320, 330 and the signal processing chip 350 are sealed in a sealing portion 38. Also, for example, a plurality of detection elements may be provided on one chip and separated by insulating portions.

The detection elements 31 to 33 are, for example, magnetic resistance elements such as AMR sensor, TMR sensor, GMR sensor, or Hall elements, and detect a magnetic field of a sensor magnet (not shown) that rotates integrally with the shaft of the motor 80, and output a set of sine and cosine signals, which are analog signals. The detection elements 31 to 33 may be the same or may have different amplitudes or the like. Furthermore, the detection element 31 may have different performances, for example, the detection element 31 may have higher detection accuracy than the detection elements 32 and 33. When different types of elements are used for at least some of the detection elements 31 to 33, the failure modes are different, so the probability of simultaneous failure can be reduced.

The signal processing unit 35 includes an AD conversion part 351, an angle calculation part 352, a rotation number calculation part 353, and a communication part 355. The AD conversion part 351 converts the sine signal and cosine signal output from the detection element 31 into digital signals.

The angle calculation part 352 uses the digitally converted detection value of the detection element 31 to calculate a motor rotation angle θm1. The rotation number calculation part 353 uses the detection value of the detection element 31 that has been digitally converted by the AD conversion part 351 to calculate the number of rotations TC of the motor 80. The number of rotations TC can be calculated based on the count value, for example, by dividing one rotation of the motor 80 into three or more regions and counting up or down according to the rotation direction each time the region changes.

The sealing portion 38 is provided with output terminals 381 to 383 and power supply terminals 385 to 388. The output terminal 381 is connected to a terminal 601 of the control unit 60 and is used to output a digital signal including a value calculated using the detection value of the detection element 31. The output terminal 382 is connected to a terminal 602 of the control unit 60 and is used to output an analog signal according to the detection value of the detection element 32. The output terminal 383 is connected to a terminal 603 of the control unit 60 and is used to output an analog signal according to the detection value of the detection element 33. Hereinafter, the configuration corresponding to the detection elements 31 to 33 is referred to as a “system”, the system using digital communication as a “digital system”, and the system using analog communication as an “analog system”.

In FIG. 2, each output terminal 381 to 383 and each communication line are provided one for each system, but a plurality of output terminals 381 to 383 and communication lines may be provided for at least some systems depending on the communication system and data system. Furthermore, an amplifier circuit, a filter circuit, etc. may be provided as appropriate. In addition, by providing NC (Non Connection) terminals among the terminals 601 to 603, it is possible to prevent a plurality of signals from becoming abnormal due to a common cause failure such as a short circuit between adjacent terminals caused by a foreign object or the like.

The power supply terminal 385 is connected to PIG power supply 900, which is directly connected to the battery. The power supply terminals 386 to 388 are connected to the IG power supplies 901 to 903, which are connected to a battery via a vehicle starting switch (hereinafter referred to as “IG”). Although the IG power supplies 901 to 903 are shown separately in FIG. 2, at least some of them may be a common power supply. Moreover, the power supply terminals 385 to 388 may be supplied with power whose voltage has been increased or decreased from each of the power supplies 900 to 903.

The power supply terminals 385 and 386 are connected to the sensor chip 310 and the signal processing chip 350. The detection element 31, AD conversion part 351, and rotation number calculation part 353, which are enclosed by a dashed line, are constantly supplied with power via the power supply terminal 385 even when the IG is off. As a result, the calculation of the number of rotations TC continues even while the IG is off.

Furthermore, when the IG is off, no power is supplied to the angle calculation part 352 and the communication part 355, and the processing stops. The power supply terminal 387 is connected to the sensor chip 320, and the power supply terminal 388 is connected to the sensor chip 330. That is, in the present embodiment, the power supply terminals 385 to 388 are provided for each of the detection elements 31 to 33, and the power supplies are configured not to interfere with each other. Furthermore, the detection elements 31 to 33 are configured to ensure insulation between the elements.

The control unit 60 is mainly composed of a microcomputer and the like, and internally includes, although not shown in the figure, a CPU, a ROM, a RAM, an I/O, a bus line for connecting these components, and the like. Each process executed by the control circuit unit 60 may be a software process or may be a hardware process. The software process may be implemented by causing the CPU to execute a program. The program may be stored beforehand in a memory device such as a ROM, that is, in a computer-readable, non-transitory, tangible storage medium. The hardware process may be implemented by a special purpose electronic circuit.

The control unit 60 has, as functional blocks, a rotation detection portion 61, a control calculation portion 69, and the like. The rotation detection portion 61 calculates a motor rotation angle θm and an absolute angle θa based on the signal from the rotation angle sensor 30, and outputs them to other calculation portions such as a control calculation portion 69. The control calculation portion 69 performs various calculations related to the drive control of the motor 80. Hereinafter, an absolute angle output from the rotation detection portion 61 is referred to as an output absolute angle θa_out.

The rotation detection portion 61 has AD conversion parts 62 and 63, an angle calculation part 64, an absolute angle calculation part 65, and an abnormality determination part 68. The AD conversion part 62 converts the analog signal output from the detection element 32 into a digital signal. The AD conversion part 63 converts the analog signal output from the detection element 33 into a digital signal. In the present embodiment, the AD conversion parts 62 and 63 are provided on the control unit 60 side, and the detection signals of the detection elements 32 and 33 are output to the control unit 60 as analog signals without being digitally converted. In other words, in the rotation angle sensor 30, the configuration related to the signal processing of the detection elements 32, 33 is omitted, and the configuration of the rotation angle sensor 30 is simplified.

The angle calculation part 64 calculates a motor rotation angle θm2 using the digitally converted detection value of the detection element 32, and calculates a motor rotation angle θm3 using the digitally converted detection value of the detection element 33.

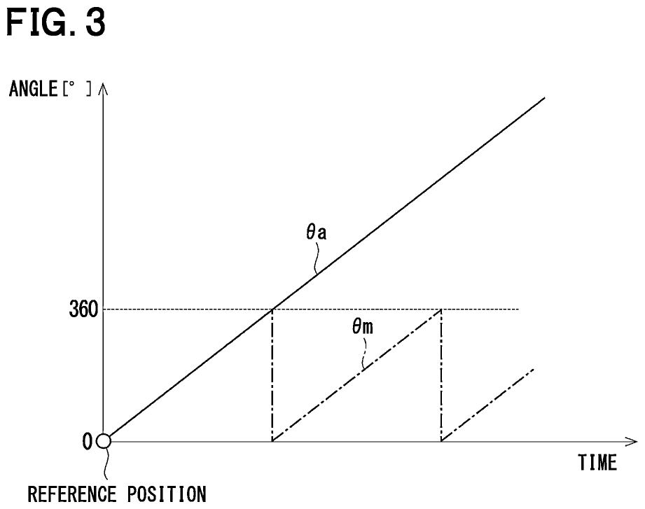

The absolute angle calculation part 65 calculates the absolute angle θa, which is the rotation angle from a reference position including multiple rotation information, based on the motor rotation angles θm1 to θm3 and the number of rotations TC (see FIG. 3). The absolute angle θa is a value that can be converted into the steering angle θs using a gear ratio or the like. In addition, FIG. 3 shows a case where the motor is rotated in the forward direction from the reference position.

Hereinafter, the motor rotation angle θm1 based on the digital signal is referred to as a digital rotation angle θm_d, and the motor rotation angles θm2 and θm3 based on the analog signals is referred to as an analog rotation angle θm_a. The absolute angle obtained by using the digital rotation angle θm_d in the current calculation is defined as a digital absolute angle θa_d, and the absolute angle obtained by using the analog rotation angle θm_a in the current calculation is defined as an analog absolute angle θa_a. When no distinction is made between digital and analog, it is simply referred to as the motor rotation angle θm or the absolute angle θa.

The abnormality determination part 68 performs abnormality determination for the motor rotation angles θm1 to θm3. In the present embodiment, three detection elements 31 to 33 are provided for one control unit 60. Therefore, even if an abnormality occurs in one detection element, it is possible to identify the element in which the abnormality occurred and continue control and abnormality monitoring based on the detection values of normal elements. Hereinafter, the term “abnormality of an element” refers not only to an abnormality of the element itself but also to a signal abnormality including an abnormality of the transmission path or the like.

Here, in calculating the absolute angle θa, at least the initial calculation requires information on the number of rotations TC. In the calculation of the number of rotations TC, a digital IC is required on the rotation angle sensor 30 side, and calculation delays occur due to angle calculation in the digital IC and digital communication such as SPI communication. Therefore, compared to when a detection signal is received as an analog signal from the rotation angle sensor 30, the calculated absolute angle also includes a delay.

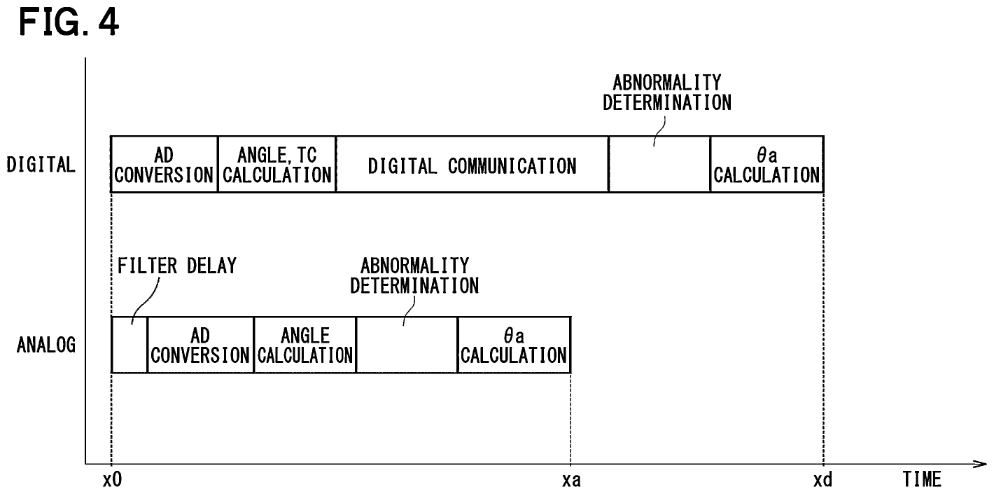

Specifically, as shown in FIG. 4, when the motor rotation angle θm1 and the number of rotations TC are calculated within the rotation angle sensor 30 using the value detected at time x0 and transmitted to the control unit 60 by digital communication, the calculation of the absolute angle is completed at time xd. In contrast, when angle calculations and the like are performed in the control unit 60 using the analog rotation angle θm_a, the calculation of the absolute angle is completed at time xa, which is earlier than time xd. In the initial calculation, since information on the number of rotations TC is required to calculate the absolute angle, digital communication becomes rate-controlling.

Therefore, in the present embodiment, an abnormality is determined by comparing the three motor rotation angles θm1 to θm3, and when either of the motor rotation angles θm2, θm3 obtained through analog communication, which has a relatively small delay, is normal, the absolute angle is calculated using the motor rotation angles θm2, θm3.

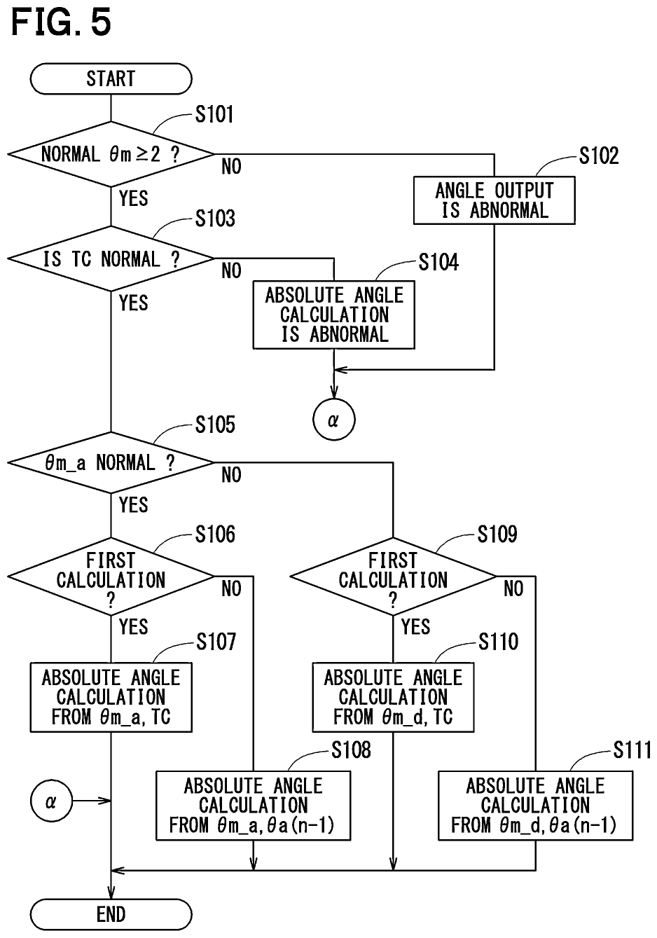

The angle calculation process of the present embodiment will be described with reference to the flowchart of FIG. 5. This process is carried out by the control unit 60 at a predetermined cycle. Hereinafter, “step” in step S101 is omitted, and is simply referred to as a symbol “S”. In the present embodiment, there is one digital system and two analog systems, but the process is described as applicable to the case of two or more digital systems, for example, two digital systems and one analog system. The same applies to the process according to the embodiment described below. In the figure, the subscript (n-1) indicates the previous value.

In S101, the abnormality determination part 68 performs an abnormality determination for the motor rotation angles θm1 to θm3, and determines whether or not there are two or more normal values. When it is determined that less than two normal values exist (S101: NO), the process proceeds to S102, where it is determined that the angle output of the motor rotation angle θm is abnormal. In addition, the angle output abnormality is notified to a higher-level ECU (not shown). When it is determined that there is two or more normal values (S101: YES), the process proceeds to S103.

In S103, the abnormality determination part 68 determines whether the number of rotations TC is normal or not. On the rotation angle sensor 30 side, when the number of rotations TC becomes abnormal due to, for example, a power failure, the rotation angle sensor 30 transmits information indicating the TC abnormality to the control unit 60. The abnormality determination part 68 performs an abnormality determination relating to the number of rotations TC based on information from the rotation angle sensor 30. When it is determined that the number of rotations TC is abnormal (S103: NO), the process proceeds to S104, where it is determined that the absolute angle calculation using the number of rotations TC is abnormal. In addition, the abnormality in the absolute angle calculation is notified to a higher-level ECU or the like. When it is determined that the number of rotations TC is normal (S103: YES), the process proceeds to S105. In the present embodiment, the number of rotations TC is not used in the calculation of the absolute angle θa except for the first calculation, so that the processes of S103 and S104 can be omitted in the second and subsequent calculations.

In S105, the abnormality determination part 68 determines whether the analog rotation angle θm_a is normal. In the present embodiment, when at least one of the motor rotation angles θm1 and θm2 is normal, a positive determination is made. When it is determined that the analog rotation angle θm_a is not normal (S105: NO), the process proceeds to S109. When it is determined that the analog rotation angle θm_a is normal (S105: YES), the process proceeds to S106.

In S106, the absolute angle calculation part 65 determines whether this is the first calculation of the absolute angle θa. When it is determined that this is the first calculation of the absolute angle θa (S106: YES), the process proceeds to S107, where an analog absolute angle θa_a is calculated using the analog rotation angle θm_a and the number of rotations TC. When it is determined that this is not the first calculation of the absolute angle θa (S106: NO), the process proceeds to S108, where the analog absolute angle θa_a is calculated using the analog rotation angle θm_a and the previous value of the absolute angle θa. In detail, the current value of the absolute angle θa is calculated by integrating the difference of the analog rotation angle θm_a. When both motor rotation angles θm2 and θm3 are normal, one of the motor rotation angles may be used, or a calculated value such as an average value may be used. The same applies when there are multiple values corresponding to the digital rotation angle.

In S109, which is proceeded when it is determined that the analog rotation angle θm_a is not normal (S105: NO), the absolute angle calculation part 65 determines whether or not this is the first calculation of the absolute angle θa, similarly to S106. When it is determined that this is the first calculation (S109: YES), the process proceeds to S110, where a digital absolute angle θa_d is calculated using the digital rotation angle θm_d and the number of rotations TC. When it is determined that this is not the first calculation (S109: NO), the process proceeds to S111, where the digital absolute angle θa_d is calculated using the digital rotation angle θm_d and the number of rotations TC. In detail, the current value of the absolute angle θa is calculated by integrating the difference of the digital rotation angle θm_d. The absolute angle calculation part 65 outputs the absolute angle θa calculated in S107, S108, S110, or S111 to the control calculation portion 69 as an output absolute angle θa_out.

In the present embodiment, one control unit 60 is configured to be able to obtain angle information from three systems. This makes it possible to identify a normal value by comparing the motor rotation angles θm1, θm2, and θm3, and to perform absolute angle calculation using the normal value. Furthermore, in the present embodiment, when the analog rotation angle θm_a is normal, the analog rotation angle θm_a is preferentially used for calculating the absolute angle, thereby making it possible to suppress calculation delays.

As described above, the rotation detection device 1 includes the rotation angle sensor 30 and the control unit 60. The rotation angle sensor 30 has at least three detection elements 31 to 33 that detect a change in a physical quantity corresponding to the rotational position of the motor 80 that is a detection target. The rotation angle sensor 30 outputs rotation angle information related to the number of rotations TC of the motor 80 according to a detection value of at least one detection element (detection element 31 in the present embodiment). Furthermore, the rotation angle sensor 30 outputs rotation angle information relating to the rotation angle of the motor 80 according to the detection values of the respective detection elements 31 to 33 as at least one analog signal and at least one digital signal.

In the present embodiment, the rotation angle sensor 30 outputs two analog signals corresponding to the detection values of the detection elements 32 and 33, and one digital signal including rotation angle information and number of rotations information corresponding to the detection value of the detection element 31.

The control unit 60 includes an absolute angle calculation part 65 and an abnormality determination part 68. The absolute angle calculation part 65 calculates the absolute angle θa, which is the amount of rotation from a reference position, using the rotation angle information related to the motor rotation angle Om and the number of rotations information related to the number of rotations TC. The abnormality determination part 68 performs an abnormality determination on the rotation angle information. In detail, the abnormality determination part 68 performs the abnormality determination by comparing the motor rotation angles θm1, θm2, and θm3.

The absolute angle calculation part 65 outputs to the control calculation portion 69 an absolute angle calculated using either the analog rotation angle θm_a, which is a rotation angle based on an analog signal, or the digital rotation angle θm_d, which is a rotation angle based on a digital signal, that is determined to be normal. In the present embodiment, the control calculation portion 69 is provided inside the control unit 60 and outputs the absolute angle θa internally, but the absolute angle θa may also be output to the outside of the control unit 60.

As a result, by outputting at least a portion of the detection values from the rotation angle sensor 30 to the control unit 60 as an analog signal, angle calculation can be performed with relatively little delay. Even when there is only one control unit 60, the absolute angle θa can be calculated based on the detection signals of three or more detection elements 31 to 33 and using values that are determined to be normal. Furthermore, when two or more detection elements are normal, the absolute angle calculation can continue using the normal angle information.

When the analog rotation angle θm_a is normal, the absolute angle calculation part 65 calculates the analog absolute angle θa_a using the analog rotation angle θm_a and the number of rotations TC in the first calculation, and in the second and subsequent calculations, calculates the analog absolute angle θa_a using the previous value and the analog rotation angle θm_a. Specifically, in the second and subsequent calculations, the analog absolute angle θa_a is calculated by integrating the difference between the previous value and the analog rotation angle θm_a. When the analog signal is normal, the analog signal is used preferentially, making it possible to perform absolute angle calculations with little delay, particularly in the second and subsequent calculations.

When all the analog rotation angles θm_a are abnormal, the absolute angle calculation part 65 calculates a digital absolute angle θa_d by using the digital rotation angle θm_d instead of the analog rotation angle θm_a. This makes it possible to continue the calculation of the absolute angle appropriately even if the analog rotation angle θm_a is abnormal.

The rotation detection device 1 is applied to an electric power steering device 8, and a motor 80, which is a detection target, outputs a torque required for steering. The steering angle can be calculated by converting the absolute angle θa into a gear ratio of a reduction gear 89 that transmits the drive of the motor 80 to a steering system 90. Thus, a steering angle sensor is omissible.

### Second Embodiment

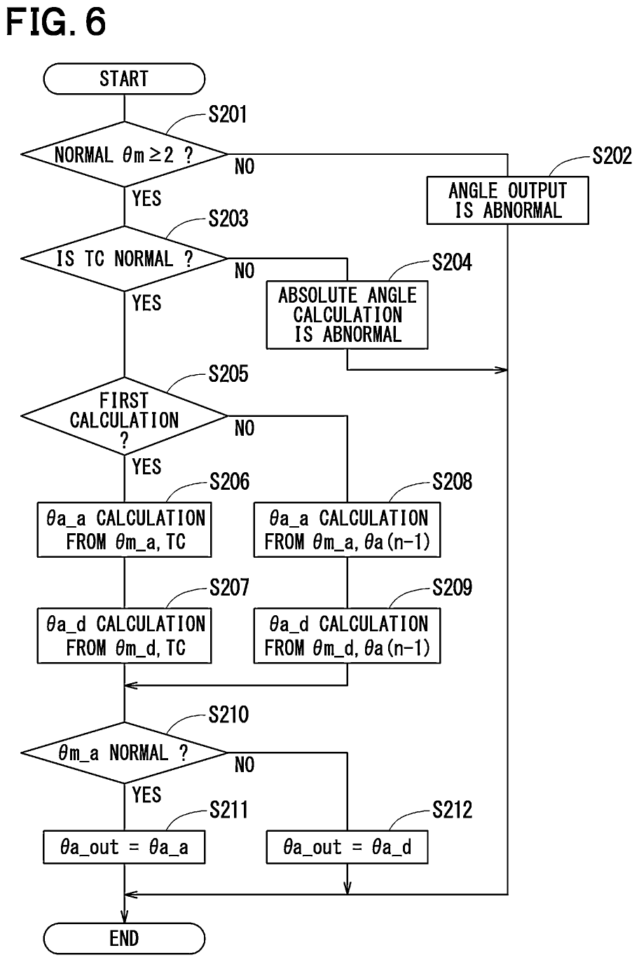

The second to fifth embodiments are different from the above embodiment in the angle calculation process, and this point will be mainly described. The angle calculation process of the second embodiment will be described with reference to the flowchart of FIG. 6. The processes from S201 to S204 in FIG. 6 are similar to the processes from S101 to S104 in FIG. 5.

In S205, the absolute angle calculation part 65 determines whether or not this is the first calculation of the absolute angle θa. When it is determined that this is the first calculation of the absolute angle θa (S205: YES), the process proceeds to S206. When it is determined that this is not the first calculation of the absolute angle θa (S205: NO), the process proceeds to S208.

In the first calculation, the absolute angle calculation part 65 calculates an analog absolute angle θa_a using the analog rotation angle θm_a and the number of rotations TC in S206, and calculates a digital absolute angle θa_d using the digital rotation angle θm_d and the number of rotations TC in S207.

In the second and subsequent calculations, the absolute angle calculation part 65 calculates the analog absolute angle θa_a using the analog rotation angle θm_a and the previous value of the absolute angle θa in S208, and calculates the digital absolute angle θa_d using the digital rotation angle θm_d and the previous value of the absolute angle θa in S209.

In S210, the absolute angle calculation part 65 determines whether the analog rotation angle θm_a is normal or not. When it is determined that the analog rotation angle θm_a is normal (S210: YES), the process proceeds to S211, wherein the output absolute angle θa_out is set to the analog absolute angle θa_a. When it is determined that the analog rotation angle θm_a is not normal (S210: NO), the process proceeds to S212, where the output absolute angle θa_out is set to the digital absolute angle θa_d. In the present embodiment, since the analog absolute angle θa_a and the digital absolute angle θa_d are calculated each time, the values can be easily switched depending on the abnormal situation.

In the present embodiment, in the first calculation, the absolute angle calculation part 65 calculates an analog absolute angle θa_a calculated using the analog rotation angle θm_a as rotation angle information, and a digital absolute angle θa_d calculated using the digital rotation angle θm_d as rotation angle information. In addition, in the second and subsequent calculations, the absolute angle calculation part 65 sets the value calculated by integrating the difference between the previous value and the analog rotation angle θm_a as the analog absolute angle θa_a, and sets the value calculated by integrating the difference between the previous value and the digital rotation angle θm_d as the digital absolute angle θa_d.

When the analog rotation angle θm_a is normal, the absolute angle calculation part 65 outputs the analog absolute angle θa_a to the control calculation portion 69 as the output absolute angle θa_out, and when all of the analog rotation angles θm_a are abnormal, the absolute angle calculation part 65 outputs the digital absolute angle θa_d to the control calculation portion 69 as the output absolute angle θa_out. The same effects as those of the above embodiments can be obtained even in the configuration described above.

### Third Embodiment

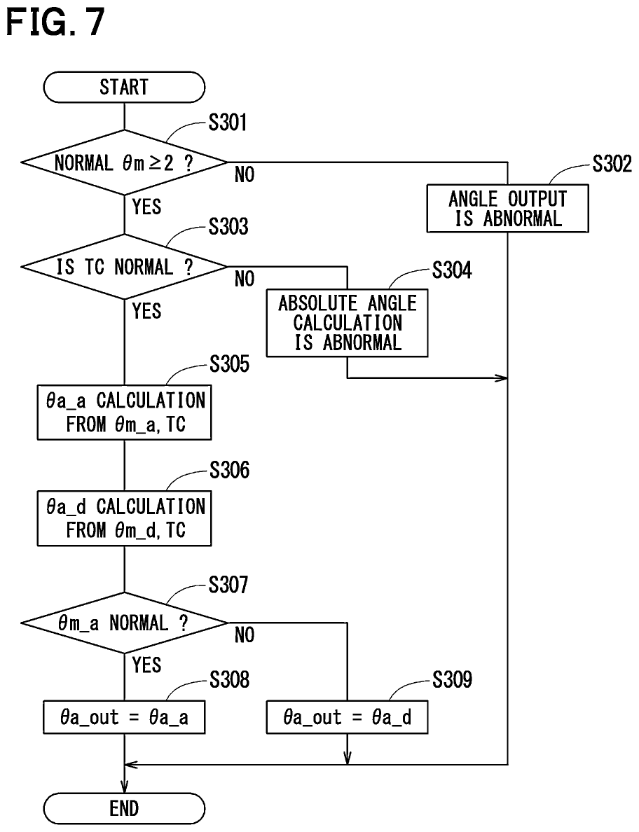

The angle calculation process of the second embodiment will be described with reference to the flowchart of FIG. 7. The processes from S301 to S304 are similar to the processes from S101 to S104 in FIG. 5. The absolute angle calculation part 65 calculates an analog absolute angle θa_a using the analog rotation angle θm_a and the number of rotations TC in S305, and calculates a digital absolute angle θa_d using the digital rotation angle θm_d and the number of rotations TC in S306.

In S307, the absolute angle calculation part 65 determines whether the analog rotation angle θm_a is normal or not. When it is determined that the analog rotation angle θm_a is normal (S307: YES), the process proceeds to S308, wherein the output absolute angle θa_out is set to the analog absolute angle θa_a. When it is determined that the analog rotation angle θm_a is not normal (S308: NO), the process proceeds to S309, where the output absolute angle θa_out is set to the digital absolute angle θa_d.

In the present embodiment, the absolute angle calculation part 65 calculates an analog absolute angle θa_a calculated using the analog rotation angle θm_a as rotation angle information, and a digital absolute angle θa_d calculated using the digital rotation angle θm_d as rotation angle information. When the analog rotation angle θm_a is normal, the absolute angle calculation part 65 outputs the analog absolute angle θa_a to the control calculation portion 69 as the output absolute angle θa_out, and when all of the analog rotation angles θm_a are abnormal, the absolute angle calculation part 65 outputs the digital absolute angle θa_d to the control calculation portion 69 as the output absolute angle θa_out.

That is, in the present embodiment, the absolute angle a is calculated using the number of rotations TC every time calculation is performed from the second calculation onwards. The same effects as those of the above embodiments can be obtained even in the configuration described above.

### Fourth Embodiment

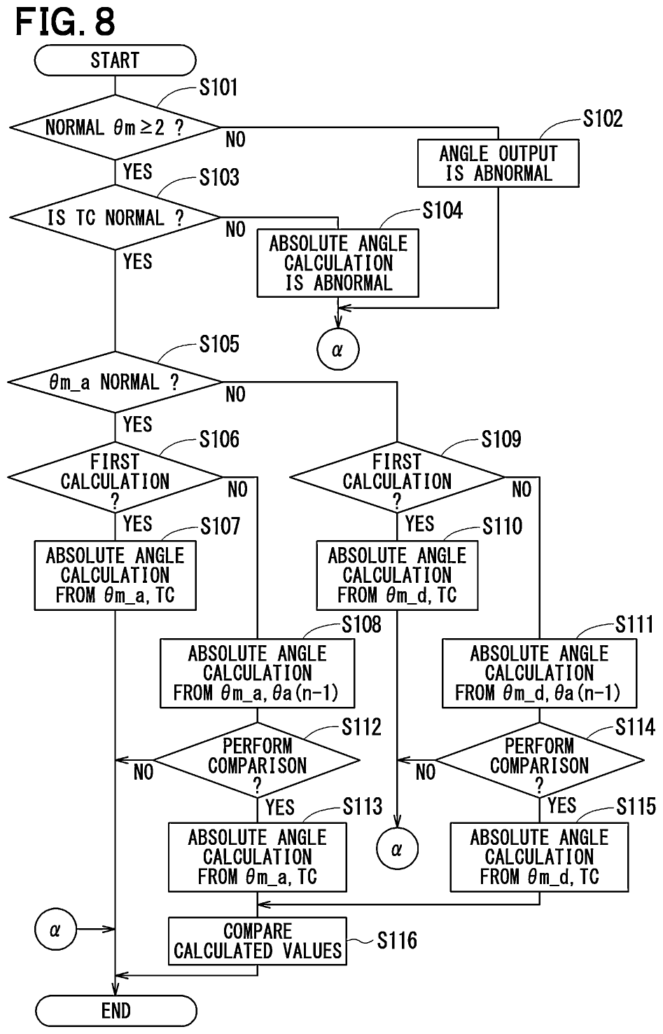

The angle calculation process of the fourth embodiment will be described with reference to the flowchart of FIG. 8. In FIG. 8, steps S112 to S114 are added to the process of FIG. 5. In S112 following S108, the control unit 60 determines whether or not it is timing to perform a comparison with a calculated value using the number of rotations TC. The timing to perform the comparison can be performed at any timing, such as at predetermined time intervals or when a predetermined condition, such as the number of steering operations, is met. When it is determined that it is not the timing to perform a comparison (S112: NO), the process from S113 onward is skipped. When it is determined that it is timing to perform a comparison (S112: YES), the process proceeds to S113. In S113, similarly to S107, the absolute angle calculation unit 65 calculates the absolute angle θa using the analog rotation angle θm_a and the number of rotations TC.

The process of S114 which follows S111 is similar to the process of S112. When it is determined that it is not the timing to perform a comparison (S114: NO), the process from S115 onwards is skipped, and when it is determined that it is the timing to perform a comparison (S114: YES), the process proceeds to S115. In S115, similarly to S110, the absolute angle calculation unit 65 calculates the absolute angle θa using the digital rotation angle θm_d and the number of rotations TC.

In S116, which follows S113 or S115, the control unit 60 compares the absolute angle θa_e calculated by integrating the difference between the previous value and the motor rotation angle θm with the absolute angle θa_tc calculated using the number of rotations TC.

In the present embodiment, from the second time onwards, the absolute angle θa_e is calculated by integrating the difference between the previous value and the motor rotation angle θm, but by periodically comparing it with the absolute angle θa_tc calculated using the number of rotations TC, it is possible to detect calculation abnormalities due to soft errors, etc. Furthermore, when the difference between the absolute angles θa_e and θa_tc is greater than a determination threshold value, the absolute angle θa_tc may be set as the output absolute angle θa_out, or a correction calculation may be performed using the absolute angle θa_tc. This makes it possible to improve the calculation accuracy. In the present embodiment, the absolute angles θa_e and θa_tc are compared in the angle calculation process of the first embodiment. However, the absolute angles θa_e and θa_tc may be compared in the angle calculation process of the second embodiment.

In the present embodiment, the absolute angle calculation part 65 calculates the absolute angle using the analog rotation angle θm_a or the digital rotation angle θm_d and the number of rotations TC at the comparison timing, and compares it with the absolute angle θa_e calculated using the previous value. This makes it possible to detect calculation abnormalities due to soft errors and the like and to correct calculation errors. In addition, the same effects as those of the above embodiment can be obtained.

### Fifth Embodiment

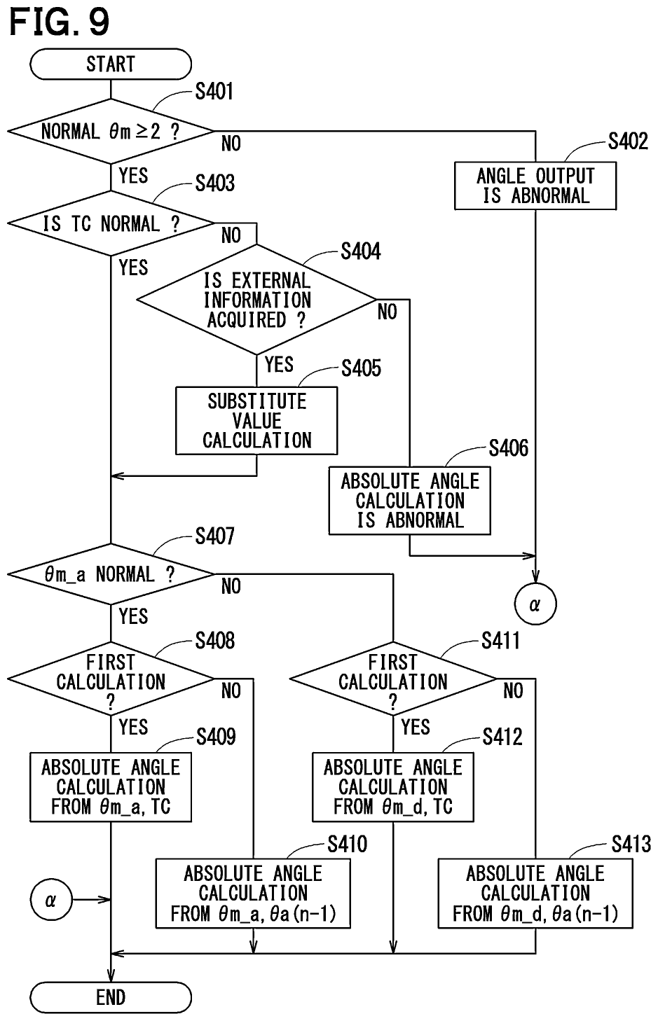

The angle calculation process of the fifth embodiment will be described with reference to the flowchart of FIG. 9. The processes from S401 to S403 are similar to the processes from S101 to S103 in FIG. 5. When it is determined in S403 that the number of rotations TC obtained from the rotation angle sensor 30 is abnormal (S403: NO), the process proceeds to S404. In S404, the control unit 60 determines whether or not external information capable of calculating the number of rotations TC can be obtained. In the present embodiment, for example, steering angle information based on a detection value of a steering sensor is defined as an external information. When it is determined that the external information can be acquired (S404: YES), the process proceeds to S405, where a substitute value for the number of rotations TC used in the absolute angle calculation is calculated based on the external information. Also, the absolute angle θa may be calculated directly from external information and used as the first calculation value. When it is determined that the external information cannot be acquired (S404: NO), the process proceeds to S406.

The processes from S406 to S413 are similar to the processes from S104 to S111 in FIG. 5. The absolute angle calculation process from S407 onward may be substituted by the calculation process of the second or third embodiment.

In the present embodiment, when the number of rotations information acquired from the rotation angle sensor 30 is abnormal, the absolute angle calculation part 65 calculates the absolute angle θa using external information acquired from a source other than the rotation angle sensor 30. As a result, even if the number of rotations information is abnormal, it can be substituted with external information, making it possible to continue the calculation of the absolute angle. In addition, the same effects as those of the above embodiment can be obtained.

### Other Embodiments

In the above embodiments, the rotation angle sensor is provided with three detection elements, and outputs one digital signal and two analog signals. In other embodiments, the number of detector elements may be four or more. Furthermore, since it is sufficient that there is at least one analog signal and at least one digital signal, the number of at least one of the analog signals and the digital signals is two or more.

In the above embodiments, the rotation angle information and the number of rotations information based on the detection value of the detection element 31 are transmitted to the control unit as one digital signal. In another embodiment, the rotation angle information and the number of rotations information may be transmitted separately. Furthermore, the number of rotations information may use a detection value of a detection element separate from the element that detects the rotation angle information.

In the above embodiments, the power supply terminal is provided for each detection element. In other embodiments, the power supply terminal may be shared by a plurality of detection elements. In the above embodiments, power is constantly supplied to the detection element 31, the AD conversion part 351, and the rotation number calculation part 353. In other embodiments, it is not necessary to constantly supply power to the detection element 31, the AD conversion part 351, and the rotation number calculation part 353.

In the above embodiments, the rotation angle sensor detects the rotation of the motor. In other embodiments, the rotation angle sensor may be other than a rotation angle sensor, such as a torque sensor or a steering sensor, and the detection target is not limited to a motor, but may be, for example, a steering shaft.

In the above embodiments, the motor is a three-phase brushless motor. In other embodiments, the motor unit is not limited to the three-phase brushless motor, and any motor may be used. Further, the motor may also be a generator, or may be a motor-generator having both of a motor function and a generator function, i.e., not necessarily be limited to the rotating electric machine. In the above embodiment, the rotation detection device is applied to the electric power steering device. As another embodiment, the rotation detection device may be applied to any other devices different from the electric power steering device.

The disclosure regarding the point that “when the number of rotations information acquired from the rotation angle sensor is abnormal, the absolute angle calculation part calculates the absolute angle using external information acquired from a source other than the rotation angle sensor” may be combined with each disclosure related to the rotation detection device. In addition, the disclosure regarding the point that “the rotation detection device is applied to an electric power steering device (8), and the motor to be detected outputs the torque required for steering” may be combined with each disclosure related to the rotation detection device.

The control circuit and method described in the present disclosure may be implemented by a special purpose computer which is configured with a memory and a processor programmed to execute one or more particular functions embodied in computer programs of the memory. Alternatively, the control circuit described in the present disclosure and the method thereof may be realized by a dedicated computer configured as a processor with one or more dedicated hardware logic circuits. Alternatively, the control circuit and method described in the present disclosure may be realized by one or more dedicated computer, which is configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium. The present disclosure is not limited to the embodiment described above but various modifications may be made within the scope of the present disclosure.

The present disclosure has been made in accordance with the embodiments. However, the present disclosure is not limited to such embodiments and configurations. The present disclosure also encompasses various modifications and variations within the scope of equivalents. Furthermore, various combination and formation, and other combination and formation including one, more than one or less than one element may be made in the present disclosure.

What is claimed is:

1. A rotation detection device, comprising:
a rotation angle sensor having at least three detection elements for detecting a change in a physical quantity corresponding to a rotation position of a detection target, being configured to output number of rotations information related to number of rotations of the detection target, and output rotation angle information related to a rotation angle of the detection target corresponding to a detection value of at least one of the detection elements; and
a control unit having an absolute angle calculation part configured to calculate an absolute angle, which is an amount of rotation from a reference position, using the rotation angle information and the number of rotations information, and an abnormality determination part configured to perform an abnormality determination on the rotation angle information;
wherein
the rotation angle sensor outputs the rotation angle information according to the detection value of at least one of the detection elements as an analog signal, and outputs the rotation angle information according to the detection value of at least one of the detection elements different from the detection element that outputs the rotation angle information as the analog signal as a digital signal, and
the absolute angle calculation part outputs to a control calculation portion an absolute angle calculated using either an analog rotation angle, which is a rotation angle based on an analog signal, or a digital rotation angle, which is a rotation angle based on a digital signal, that is determined to be normal.

2. The rotation detection device according to claim 1, wherein
when the analog rotation angle is normal, the absolute angle calculation part:
in a first calculation, calculates the absolute angle using the analog rotation angle as the rotation angle information, and
in second and subsequent calculations, calculates the absolute angle using a previous value and the analog rotation angle.

3. The rotation detection device according to claim 2, wherein
when all of the analog rotation angles are abnormal, the absolute angle calculation part calculates the absolute angle by using the digital rotation angle instead of the analog rotation angle.

4. The rotation detection device according to claim 1, wherein
the absolute angle calculation part:
in a first calculation, calculates an analog absolute angle, which is an absolute angle calculated, calculated using the analog rotation angle as the rotation angle information, and a digital absolute angle, which is an absolute angle, calculated using the digital rotation angle as the rotation angle information,
in second and subsequent calculations, a value calculated using the previous value and the analog rotation angle is defined as an analog absolute angle, and a value calculated using a previous value and the digital rotation angle is defined as a digital absolute angle,
when the analog rotation angle is normal, outputs the analog absolute angle to the control calculation portion, and when all the analog rotation angles are abnormal, outputs the digital absolute angle to the control calculation portion.

5. The rotation detection device according to claim 2, wherein
the absolute angle calculation part calculates an absolute angle using the analog rotation angle or the digital rotation angle and the number of rotations information at a comparison timing, and compares the calculated absolute angle with the absolute angle calculated using a previous value.

6. The rotation detection device according to claim 1, wherein
the absolute angle calculation part calculates an analog absolute angle, which is an absolute angle calculated, calculated using the analog rotation angle as the rotation angle information, and a digital absolute angle, which is an absolute angle, calculated using the digital rotation angle as the rotation angle information, and
when the analog rotation angle is normal, outputs the analog absolute angle to the control calculation portion, and when all the analog rotation angles are abnormal, outputs the digital absolute angle to the control calculation portion.

7. The rotation detection device according to claim 1, wherein
when the number of rotations information acquired from the rotation angle sensor is abnormal, the absolute angle calculation part calculates the absolute angle using external information acquired from a source other than the rotation angle sensor.

8. The rotation detection device according to claim 1, wherein
the rotation detection device is applied to an electric power steering device, and
a motor which is the detection target outputs a torque required for steering.

9. A rotation detection device, comprising:
a rotation angle sensor having at least three detection elements for detecting a change in a physical quantity corresponding to a rotation position of a detection target, being configured to output number of rotations information related to number of rotations of the detection target, and output rotation angle information related to a rotation angle of the detection target corresponding to a detection value of at least one of the detection elements, and being configured to output the rotation angle information according to the detection value of at least one of the detection elements as an analog signal, and output the rotation angle information according to the detection value of at least one of the detection elements different from the detection element that outputs the rotation angle information as the analog signal as a digital signal, and
a computer including a processor and a memory that stores instructions configured to, when executed by the processor, cause the processor to
calculate an absolute angle, which is an amount of rotation from a reference position, using the rotation angle information and the number of rotations information,
perform an abnormality determination on the rotation angle information, and
output to a control calculation portion an absolute angle calculated using either an analog rotation angle, which is a rotation angle based on an analog signal, or a digital rotation angle, which is a rotation angle based on a digital signal, that is determined to be normal.

10. The rotation detection device according to claim 9, wherein
when the analog rotation angle is normal, the computer causes the processor to:
in a first calculation, calculate the absolute angle using the analog rotation angle as the rotation angle information, and
in second and subsequent calculations, calculate the absolute angle using a previous value and the analog rotation angle.

11. The rotation detection device according to claim 10, wherein
when all of the analog rotation angles are abnormal, the computer causes the processor to calculate the absolute angle by using the digital rotation angle instead of the analog rotation angle.

12. The rotation detection device according to claim 9, wherein
the computer causes the processor to:
in a first calculation, calculate an analog absolute angle, which is an absolute angle calculated, calculated using the analog rotation angle as the rotation angle information, and a digital absolute angle, which is an absolute angle, calculated using the digital rotation angle as the rotation angle information,
in second and subsequent calculations, a value calculated using the previous value and the analog rotation angle is defined as an analog absolute angle, and a value calculated using a previous value and the digital rotation angle is defined as a digital absolute angle, and
the computer causes the processor to:
when the analog rotation angle is normal, output the analog absolute angle to the control calculation portion, and
when all the analog rotation angles are abnormal, output the digital absolute angle to the control calculation portion.

13. The rotation detection device according to claim 10, wherein
the computer causes the processor to calculate an absolute angle using the analog rotation angle or the digital rotation angle and the number of rotations information at a comparison timing, and compare the calculated absolute angle with the absolute angle calculated using a previous value.

14. The rotation detection device according to claim 9, wherein
the computer causes the processor to
calculate an analog absolute angle, which is an absolute angle calculated, calculated using the analog rotation angle as the rotation angle information, and a digital absolute angle, which is an absolute angle, calculated using the digital rotation angle as the rotation angle information,
when the analog rotation angle is normal, output the analog absolute angle to the control calculation portion, and
when all the analog rotation angles are abnormal, output the digital absolute angle to the control calculation portion.

15. The rotation detection device according to claim 9, wherein
the computer causes the processor to
when the number of rotations information acquired from the rotation angle sensor is abnormal, calculate the absolute angle using external information acquired from a source other than the rotation angle sensor.

16. The rotation detection device according to claim 9, wherein
the rotation detection device is applied to an electric power steering device, and
a motor which is the detection target outputs a torque required for steering.
